(19) United States
(12) Patent Application Publication
(10) Pub. No.: US 2004/0013775 A1
(43) Pub. Date: Jan. 22, 2004

(54) Chocolate with raised design

(76) Inventors: Nathaniel Gordon Hilary Lucas, Arundell (AU); John Wesley Taylor, Burleigh (AU)

Correspondence Address: Reed Smith Hazel & Thomas, Suite 1400, 3110 Fairview Park Drive, Falls Church, VA, 22042, US

(21) Appl. No.: 10/362,454

(22) PCT Filed: Aug. 27, 2001
(86) PCT No.: PCT/AU01/01067

(51) Int. Cl. A23L 1/27

(52) U.S. Cl. 426/249

(57) ABSTRACT

A method for producing a chocolate product, which may be filled, with a thin, raised design thereon of multiple colours (10a-d) employs a plurality of screens (63) laid over a first mould plate (20) to enable the different chocolate colours (10a-d) to be selectively placed in a computer engraved pattern (10) in the first mould plate (120).

### BACKGROUND OF THE INVENTION

1. Field of the Invention

THIS INVENTION relates to an improved chocolate product and a method of producing same.

In particular, the invention relates to a method of producing a chocolate product having letters and/or other designs (eg., corporate trade mark) formed thereon of a different color, or colors, of chocolate or chocolate-like material than the rest (ie., body) of the chocolate product.

Throughout the specification, the term “chocolate” is intended to include within its scope chocolate, chocolate-like material and chocolate substitute, eg., carob.

2. Prior Art

AU-B-66814/86 (583969) (GARRY JOHN GREEN) disclosed a method of forming a chocolate product having a thin raised design thereon of a different color than the rest of the chocolate product.

While the method disclosed in that specification enable a design formed in chocolate of one color to be applied to chocolate of a second color with a high degree of accuracy, the method, in practice, has a number of practical limitations.

In practice, the patterns or designs (eg., up to 36 in number) are engraved in a mould plate. Chocolate of a first color is placed on the mould plate and spread over the plate, eg., with a plastic spatula, to fill the mould cavities and any excess chocolate is wiped off the exposed surface of the mould plate; eg., with tissue paper. A layer of the chocolate of the second color is spread over the mould plate by hand, eg., using a spatula. The mould plate is shaken to remove any air bubbles; and is placed in a cooler, eg., for 10 minutes. When the chocolate is solid, the chocolate product is stripped from the mould plate and is then cut into squares using a knife guided by a template, which is placed over the exposed surface of the chocolate product bearing the design.

The above method has the following practical problems:

a) the actual thickness, and any variation in thickness, of the chocolate product formed from the second colored chocolate is dependent solely on the operator's skill;

b) cutting of the chocolate products from the solid sheet of chocolate is labourious, as the template must be (aid Qn the sheet to enable, eg., the horizontal cuts, to be made and then rotated through 90 degrees to enable the vertical cuts to be made;

c) the location of the design on the chocolate products is variable, dependent on the placement of the cutting template on the chocolate sheet; and

d) the comers of the chocolate products are likely to crack and break as the products are cut from the sheet.

A rejection rate of 50% is not uncommon. While the chocolate may be melted and re-used, the operator's time cannot be recycled and so productivity is relatively low.

To ameleriote the rejection rate of the chocolate products manufactured by the Green method, Intemational Publication WO 97/39636 (=PCT/AU97/00245) (CHOCOLATE MAKERS INTERNATIONAL PTY LTD et al) disclosed a method where the pattern is engraved in a first mould plate, the pattern is filled with a chocolate of a first color, and second mould plate is placed with a mould cavity in registry with the pattern, and the mould cavity is filled with a chocolate of a second color when the chocolate is cooled, the chocolate product is stripped from the mould plates.

This method markedly reduced the rejection rates and also allowed the chocolate products to have a wide range of shapes/thicknesses.

However, the method disclosed in WO 97/39636 (CHOCOLATE MAKERS) did not enable a pattern with two or more colors to be formed on the chocolate; and did not allow a pattern, with one or more colors, to be formed on a filled chocolate product, the filling being eg., a fruit-, chocolate-, coffee- or the like flavored cream- or jelly-like filling.

### SUMMARY OF THE PRESENT INVENTION

It is an object of the present invention to provide a method for producing a chocolate product having a pattern, in two or more colors, formed on the body of the chocolate product.

It is another object of the present invention to provide a method for producing a chocolate product having a pattern, in at least one color, on the body of the chocolate product, wherein the body contains a filling.

It is a preferred object that the pattern, or patterns, on the chocolate product have a thin raised design, eg., ≦0.5 mm high, with sharply defined shape(s)/border(s).

It is a further preferred object to provide a method where the bodies of the chocolate products can have a wide range of shapes.

It is a still further preferred object to provide such a method which, while capable of being effected manually, is readily automated, requires little operation skills and has low rejection rates.

It is a still further preferred object to provide a chocolate product manufactured by the method.

Other preferred object will become apparent from the following description.

In one aspect, the present invention resides in a method of forming a chocolate product having a thin (ie., three-dimensional) raised design thereon of two or more different colors than the rest (or body) of the chocolate product, said method comprising the steps of:

a) engraving a pattern in a first mould plate, the pattern being a mirror-image of the desired design on the product;

b) applying a screen to the first mould plate to limit exposure of the engraved pattern only to the portion, or portions, of a first color;

c) introducing into the portion, or portions, sufficient liquid chocolate of the first color to at least fill the portion or portions;

d) removing any excess material of the chocolate of the first color from the first mould plate;

e) respectively repeating steps (b) to (d) respectively for the portion, or portions, of chocolates of second or more colors;

f) placing a second mould plate in non-slip contact, with the first mould plate, the second mould plate having a mould cavity of selected shape therein in register with the engraved pattern;

g) introducing liquid chocolate selected for the rest (or body) of the chocolate product into the mould cavity to cover the chocolate of the first and second (and more) colors;

h) cooling the different colored chocolates in the mould plates to solidify them and bond (or meld) them together; and

i) removing the resultant chocolate product so formed from the mould plates.

If the chocolate product is to be a filled chocolate product, the fill material and the liquid chocolate for the rest (or body) of the chocolate product are introduced simultaneously in step (g).

Where only chocolate of one color is to be provided for the design on a filled chocolate product, step (e) is omitted.

Preferably, a plurality of identical patterns are engraved in the first mould plate, eg., by computer assisted engraving, the patterns having optional three dimensional features such as shape and height.

Preferably, a respective mould cavity for each pattern is provided in the second mould plate.

Preferably, the first and second plates are formed of resilient plastics material, the first mould plate being preferably formed from an engraving plastic laminate and the second mould plate being preferably formed from a silicone rubber or polyurethane.

The colors of the chocolates deposited in the pattern can be any color, eg., (a) red/white/blue for the “STARS AND STRIPES”, and (b) blue and white for the “FORD” (Registered Trade Mark) oval device and red/blue/yellow/green/black for the “MICROSOFT WINDOWS” label (Registered Trade Mark).

The mould cavities in the second mould plate preferably have inclined or bevelled side walls to enable the chocolate products to be easily stripped therefrom; and in plan view may be square, triangular, elliptical, circular, heart-shaped, fan-shaped or any other regular or irregular shape.

In a second aspect, the present invention resides in apparatus to effect this method.

In a third aspect, the present invention resides in chocolate products manufactured by the method.

### BRIEF DESCRIPTION OF THE DRAWINGS

To enable the invention to be fully understood, preferred embodiments will now be described with reference to the accompanying drawings, in which:

FIG. 1 is a schematic view of the engraving of the cavities into the first mould plate;

FIG. 2 is a sectional side view of the one pattern engraved on the first mould plate taken on line 2-2 on FIG. 1;

FIG. 3 is a (right) side elevational view of an application station for a colored chocolate into the cavities in the first mould plate;

FIG. 4 is a top plan view thereof;

FIG. 5 is a front elevational view thereof, the printer being omitted;

FIGS. 5(a) to 5(d) are schematic drawings showing the steps of screening the pattern for two colours, applying the colours and removing the excess chocolate;

FIG. 6 is an exploded perspective view of a mould assembly;

FIG. 7 is a top plan view of the mould assembly;

FIG. 8 is a sectional side view of the mould assembly;

FIG. 9 is a front elevational view of a “one-shot depositor” machine; and

FIG. 10 is a sectional side view showing chocolate and filling being deposited in the mould assembly;

FIG. 11 is a schematic sectional side view of a cooling tower for the chocolate product;

FIG. 12 is an end elevational view of the cooling tower,

FIGS. 13(a)(b)(c)(d) are schematic drawings showing the manual colour screening application steps whereby the various screens and colours are manually applied; and

FIG. 14 is the manual alternative to FIG. 10, whereby the chocolate is manually deposited in the mould assembly.

### DETAILED DESCRIPTION OF THE PREFERRED EMBODIMENTS

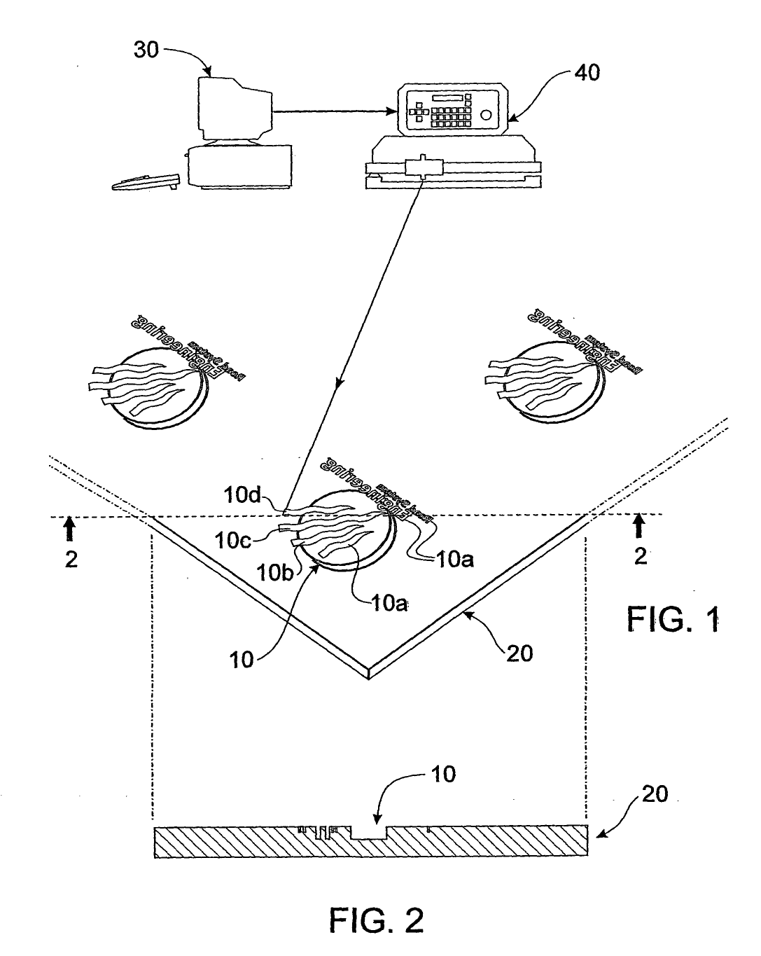

Referring to FIGS. 1 and 2, a pattern 10, which is a mirror-image of the desired 3-dimensional patent or design to be applied to the chocolate product, is engraved into the first mould plate 20 (or graphics plate), the first mould plate 20 being formed from an engraving plastics laminate.

In the example illustrated in FIGS. 1 and 2, the final design will have chocolate of four colors (eg., red 10a/blue 10b/yellow 10c/white 10d) applied to the chocolate product.

The proposed design is entered into a computer graphics program in a computer 30 and may be in the form of a rough sketch, detailed drawing, photograph or object. The computer graphic designer can enhance the design to produce a mirror-image which is accurate in detail, suited to the chocolate product, size and shape (“smoothed” on all edges for a quality finish and to ensure good relief from the first mould plate 20 during manufacture).

By utilising 3-dimensional technology, the computer program is able to accurately design 3-dimensional graphic layouts and photographic imaging with a high degree of accuracy in readiness for transference to the computer-assisted engraver 40.

The 3-dimensional graphics, or photo imagery are in the developmental stages of modem engraving machines, which makes the program not only relatively new in standard engraving operations, but totally new in chocolates manufactured with a raised chocolate design.

Once completed, the design is transferred to the computer-assisted engraver 40 and the chocolate size determines how many times the design 10 can be engraved in a first mould plate, ie., 20 duplicated designs will result in 20 chocolates per plate.

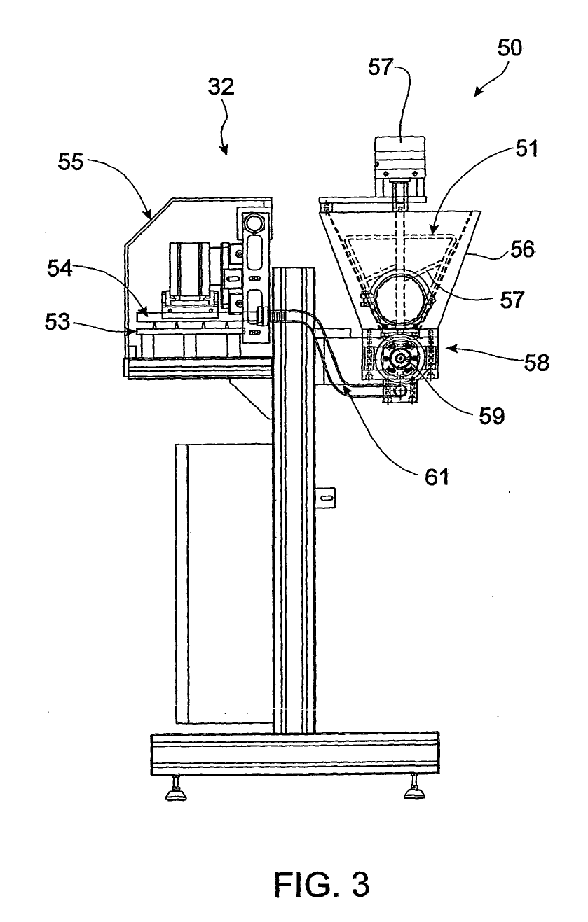

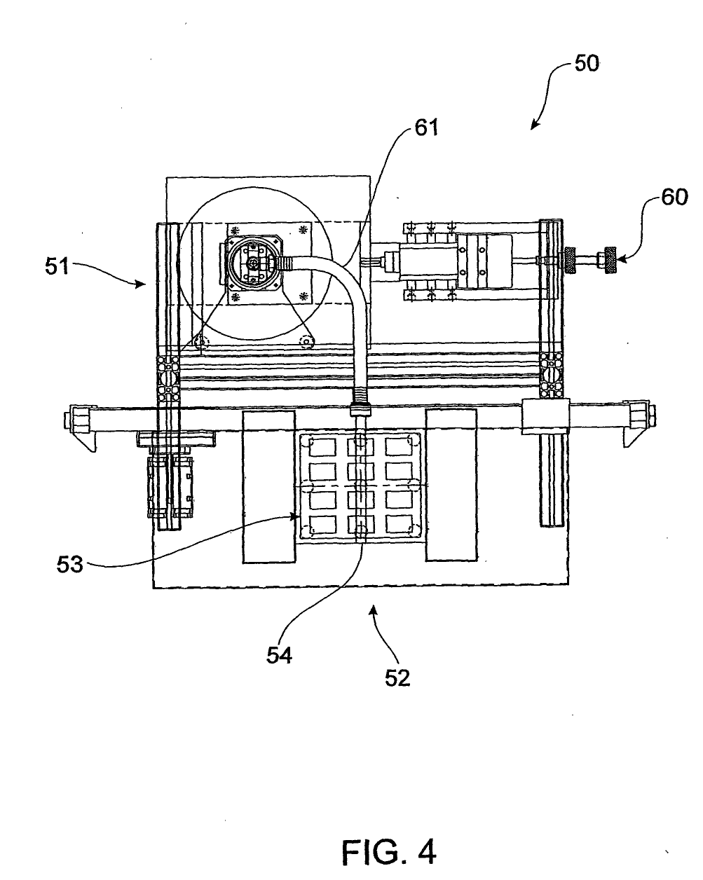

When the first mould plate 20 has been completed, it is transferred to a first applicator station 50 illustrated in FIGS. 3 to 5.

A small bulk chocolate depositor 51 is designed to fit onto the rear of a modified screen printing machine 52 which has a graphic plate table 53, a nozzle 54 and a cover hood 55.

The chocolate depositor 51 has a stainless steel water jacketed tank with high accuracy heating controls for both pure chocolate and compound chocolate. The depositor has a hopper 56 fitted with a stirrer 57 to ensure constant and even viscosity of the colored chocolate prior to deposition.

An aluminium tooling plate block 58 is provided under the hopper 56 and is fitted with a stainless steel rotary valve/piston combination 59 which is easily removable for cleaning and product changes, ie., for milk to white chocolate colors, or white to red/blue/yellow/green colors.

The product adjuster 60 controls how much chocolate is deposited into the patterns 10 in the first mould plate 20 (the latter being supported by the graphic plate table 53).

A flexible tube 61 transfers the metered amount of colored chocolate to the deposit nozzle 54 (which is readily interchangeable for different first mould plate 20 layout).

The deposit nozzle 54 is mounted between two spreader blades 62, being possible to deposit before each stroke or during each stroke of the spreader blades 62, whichever gives the best results. The cleaning of the excess color chocolate from the first mould plate is carried out by the spreader blades 62, preferably formed of silicone, where one is activated downwards to scrape to the left and the other is activated downwards to scrape to the right.

To apply the different color combinations to the designs 10 on the first mould plate 20, a screen 63 has been designed to fit over the first mould plate 20 and is attached to the applicator station (below the deposit nozzle 64) to only allow access to specific cavities (or portions or zones) of the designs 10 on the first mould plate 20.

To enable a second color to be applied to the designs 10 on the first mould plate 20, the first mould plate 20 is transferred to a second similar applicator station 50 positioned adjacent the first applicator station and the second color is applied. A separate applicator station is required for each different color in the final design.

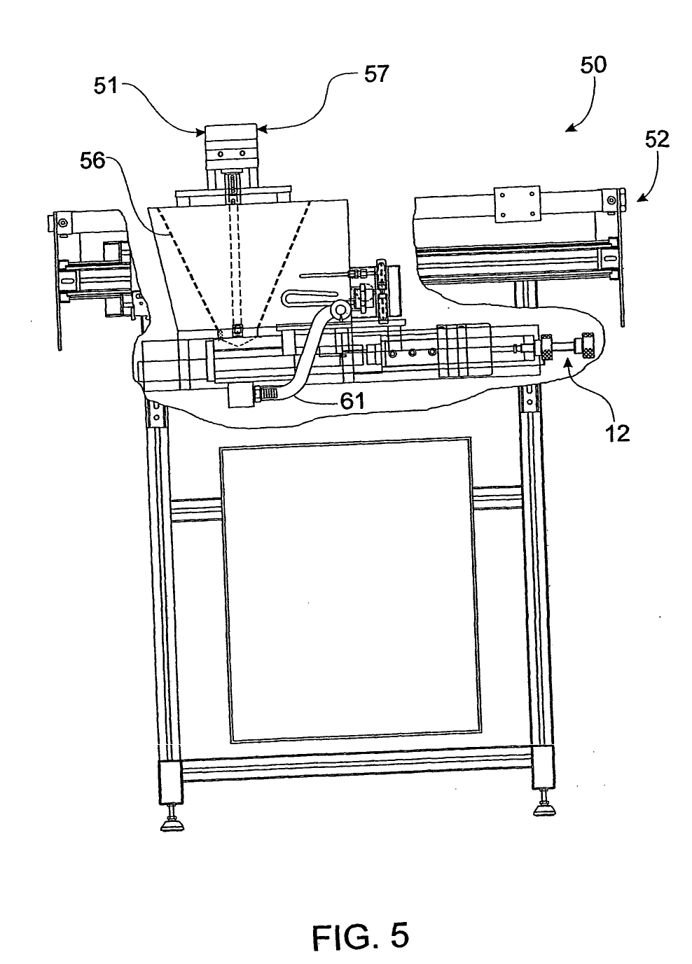

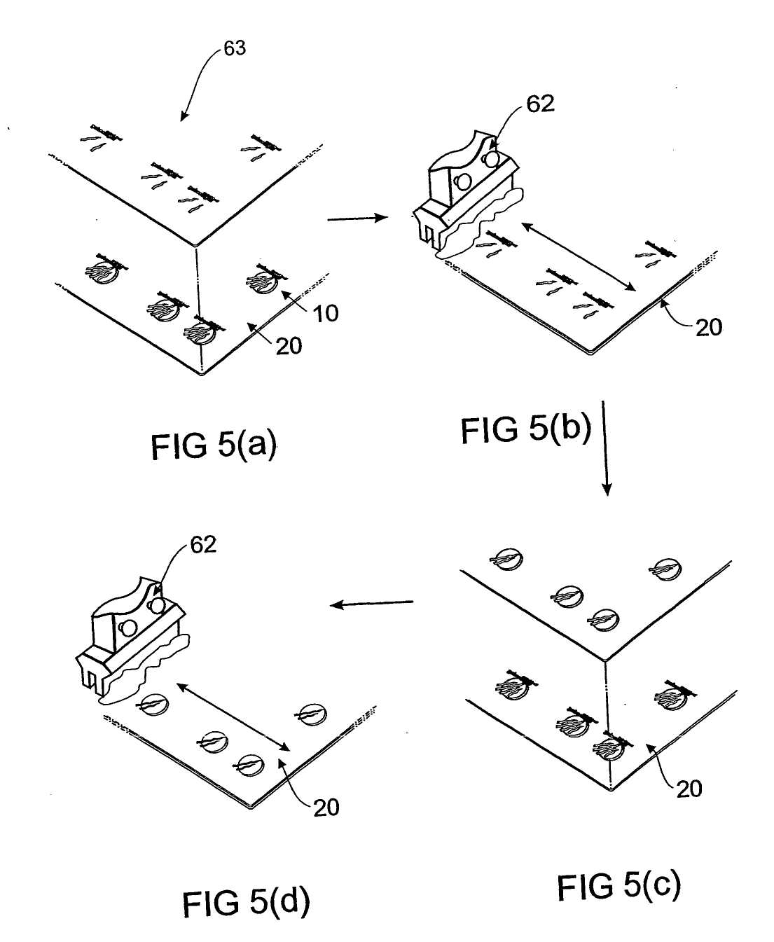

FIG. 5(a) shows how a screen 63 placed over the first mould plate 20 to enable eg the red colour chocolate to be applied to the design 10. The screen 63 is placed in registry with the first mould plate and red chocolate is applied by the deposit nozzle 54. Excess red chocolate is scrapped off by the scraper blade 62—see FIG. 5(b).

At the next applicator station 50, a screen 63 for a second colour is placed over the first mould plate 20—see FIG. 5(c) and the eg blue chocolate is deposited and the excess chocolate scraped off—see FIG. 5(d).

The screens 63 placed over the first mould plate 20 in the applicator stations 50 operate in a similar manner to the screens in a conventional screen printing machine.

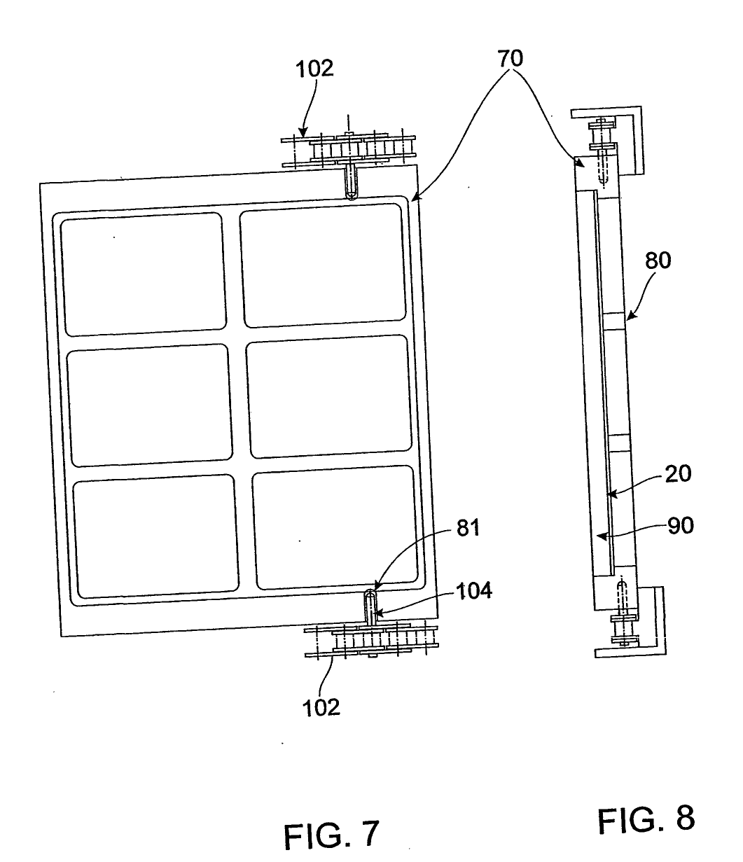

When the different color chocolates have been applied to the patterns 10 in the first mould plate 20, the mould plate must become part of a mould assembly 70—see FIGS. 5 to 8. The mould assembly 70 is relatively simple, but it is critical to ensure accuracy of the finished product and comprises three components—a mould cavity plate 80, the first mould plate 20 and second mould plate 90 to be hereinafter described.

The mould carry frame 80 is formed of resilient plastic or nylon construction that is designed to carry the first mould plate 20 and the second mould plate 90 through the process as an assembled unit. Locating notches 81 in the base of the mould carry frame accurately position the mould assembly 70 for the remainder of the process. The skeleton-type structure of the mould carry frame base 80 with holes 82 therethrough is to allow any particles that may adhere to the base of the first mould plate 20 to not prevent the plate 20 fitting flat in the frame 80.

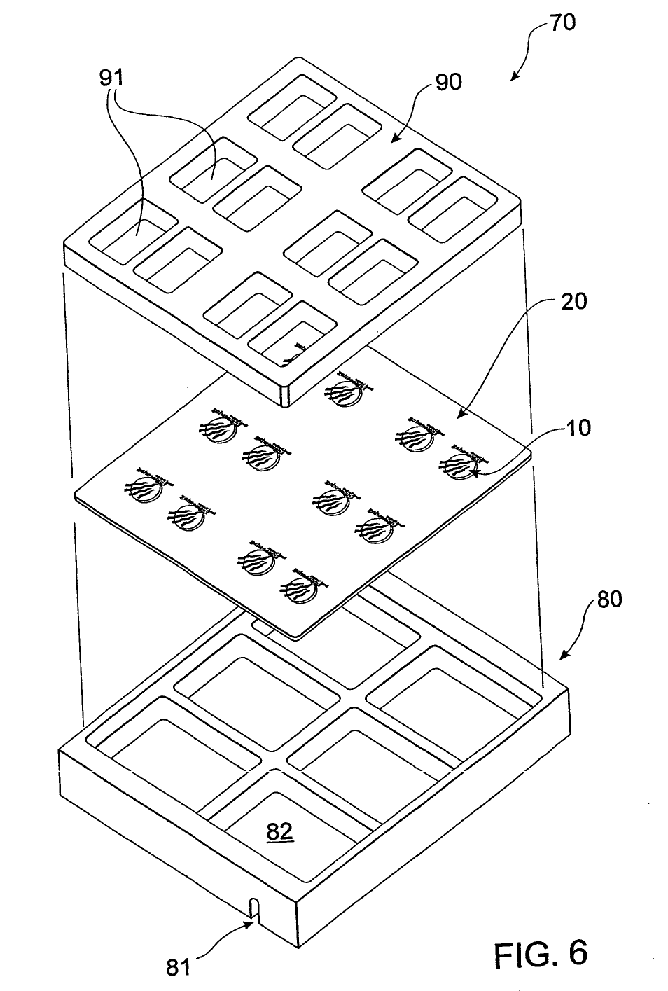

As illustrated, particularly in FIG. 6, the first mould plate 20 is placed in the mould frame 80 with the chocolate filled graphics facing upwards. The plate 20 is made to fit perfectly within the frame 80 having no lateral movement whatsoever.

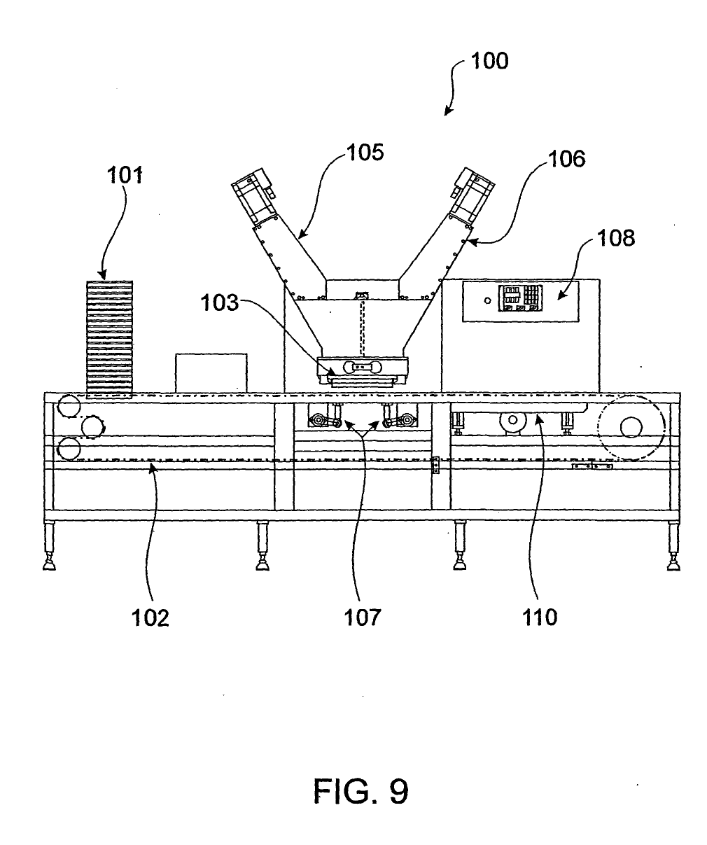

The second mould plate 90 is formed of a pliable silicone rubber compound which will self-adhere to the first mould plate 20 and provide a different sized and shaped cavities to suit the designs 10 on the first mould plate 20. Both the second mould plate 90 and the first mould plate 20 material are so designed that when placed together, they form a non-slip contact. This, when combined with self-adhesive qualities prevents any chocolate residue ingress between the two mould plates 20, 90. The second mould plate 90 also fits perfectly within the mould carry frame 80, the cavities 91 in the second mould plate 90 matching the designs 10 in the first mould plate exactly. The completed mould assembly is now placed into the feeder 101 of the one-shot depositor machine 100 illustrated in FIG. 9.

The feeder 101 is arranged above an index chain 102, upstream of the head of the depositor plate 103 of the one-shot depositing machine 100.

The notches 81 in the base of the mould carry frames 80 are arranged to releasably engage the locking pins 104 on the index chain 102. The feeder 101 ensures that the mould assemblies 70 are placed squarely on, and locate onto, the index chain 102.

The mould assembly 70 is conveyed by the index chain through the one-shot depositing machine 100. A chain 102 indexes the mould assemblies 70 at predetermined intervals to the one-shot chocolate depositing heads, being two sets of depositing heads, the first set for depositing the centre filling 201 of the chocolate product, and the second set for depositing the shell 202 of the chocolate product in the two heads 105, 106 via a lock plate 103.

When the mould assembly 90 reaches a position indexed below the block plate 103, the mould assembly is raised by a mould lift table 107 until it makes contact with the block plate 103. At this point, the injection process takes place, being a computer controlled process via computer 108 to ensure that deposited amounts of centre fill 201 and shell fill 202 are deposited in the cavities 91 in the second mould plate 90. (The centre fill 201 and shell fill 202 are deposited via injection nozzles (not shown) in block plate 103.)

A suck-back system on the injector nozzles within the heads ensure a clean deposit every time.

Once the position is complete, the mould assembly 70 is lowered and then indexed to a vibrating table 110 where vibration is introduced to settle and flatten the chocolate. The moulding process is now complete, the next stage being to cool the finished product.

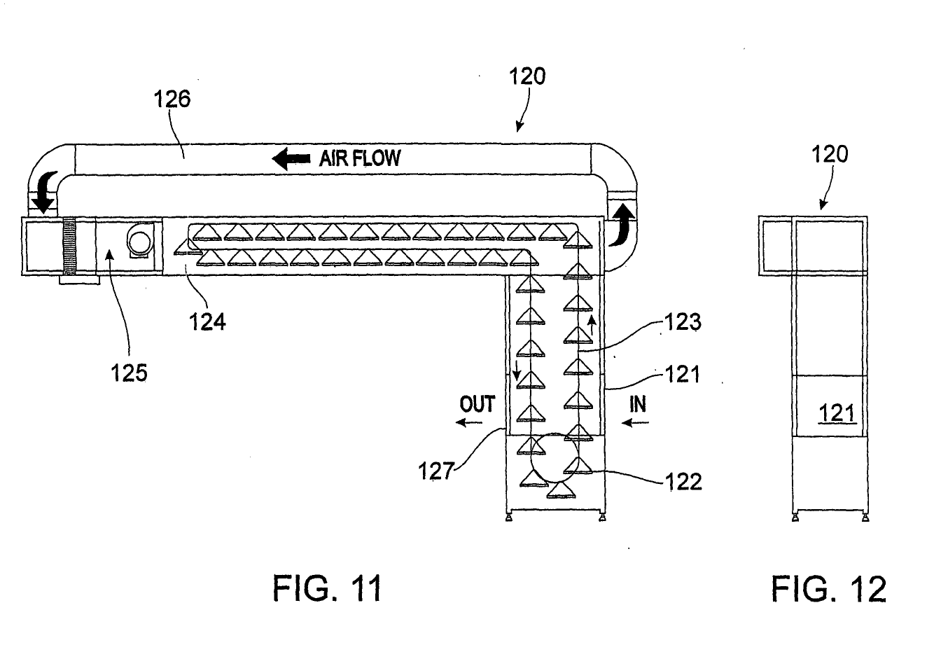

Referring to FIGS. 11 and 12, the (now filled) mould assembly 70 is passed through an entrance 121 in a cooling tower unit 120 and placed on a stainless steel tray 122 suspended from a transport chain 123. Mould assemblies are carried through the cooling tower zone 124 which is cooled by an air cooler refrigeration unit 125 which has a recirculating air flow. (The cooling tower zone 124 may be mounted above or below the ceiling of the building to minimise the floor space of the cooling tower unit 120.) When the chocolates have been cooled, mould assemblies are extracted from the cooling tower via outlet 127.

When the mould assembly 20 has been removed from the cooling tower 120, the completed chocolates are now removed from the assembly through a “de-moulding” step.

The mould assembly is turned upside down on a bench and by pushing on the back of the mould carry frame 80 onto the first mould plate 20, the first mould plate 20 and the second mould plate 90 can be easily removed from the mould carry frame 80. With the second mould plate 90 on the bench, the first mould plate 20 can be gently peeled away while holding the second mould plate 90 down. It is then a simple process to push the completed chocolates out of the second mould plate 90.

The chocolate product is then ready for packaging.

As hereinbefore described, the number of applicator stations 50 required will depend on the number of different colors of chocolate to be deposited in the patterns 10 on the first mould plate 20. For example, to produce the design of the “stars and stripes” along a milk chocolate background, three applicator stations will be required for the colors red, white and blue, respectively.

The complete chocolate product can have a solid chocolate body by only operating the chocolate head 105 of the chocolate depositing machine 100. Alternatively, for a filled chocolate, both heads 105 and 106 are operated.

The processes hereinbefore described can also be varied from a fully automated process to a manual operation.

This is achieved without any change to the invention simply by substituting the automated application portions of the process (FIGS. 3, 4, 5(a)(b)(c)(d), 6, 7, 8, 9, 10 and references to the machinery in these figures with a manual process.

The basis of the changes are reflected in two areas of the automated process:

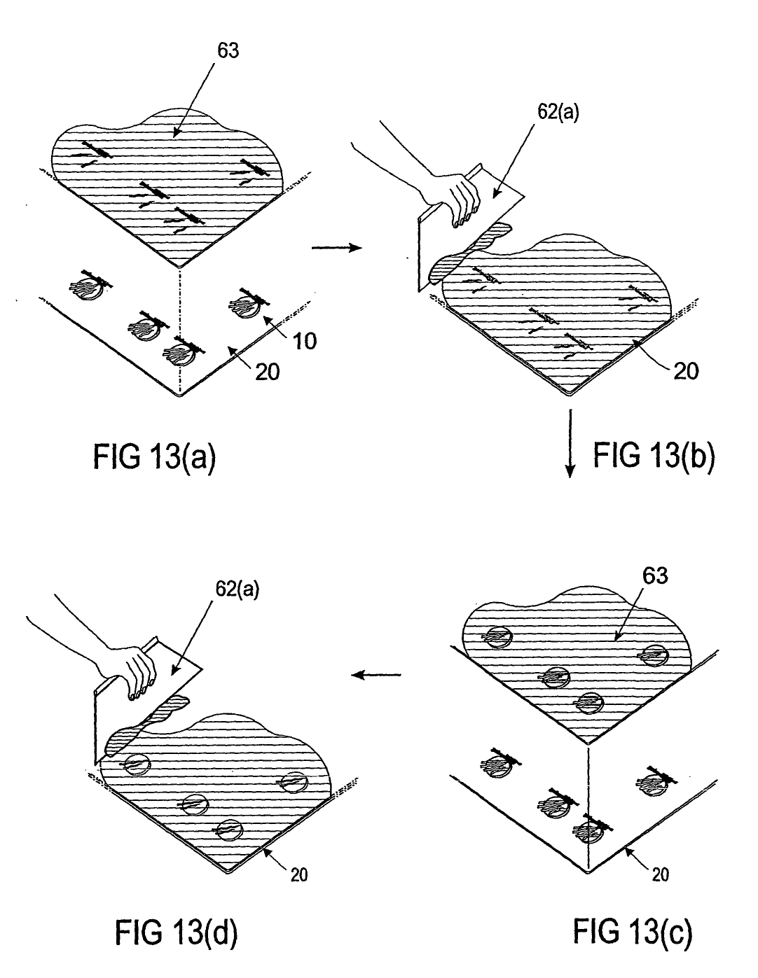

a) where the colour combinations 10(a)(b)(c)(d) are applied by a screening process through a series of applicator stations FIG. 3, the same screen 63 are manually placed onto the mould plate 20 and the colour manually applied to the engraved cavities 10—see FIGS. 13(a)(b)(c)(d)—repeating the process the same as the automated process for each additional colour; and

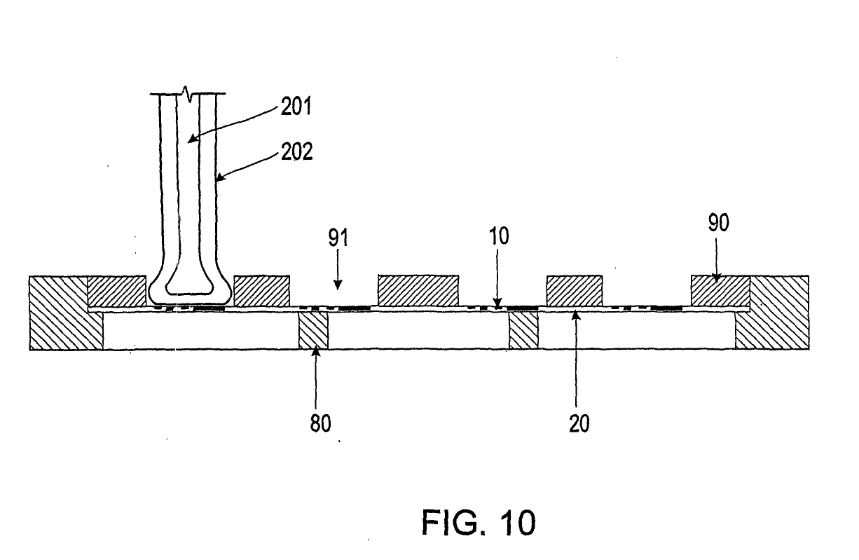

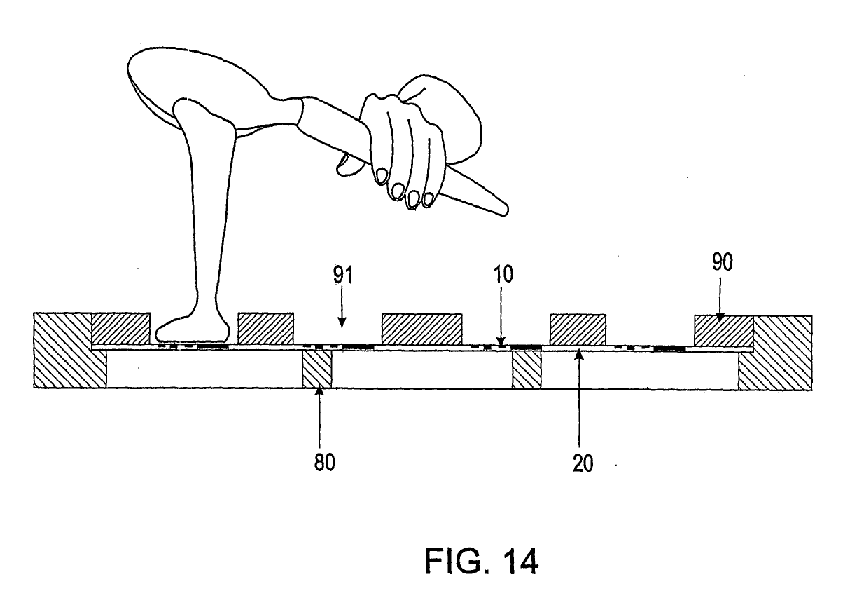

b) after all the colours have been applied—as per FIG. 13(a)(b)(c) and (d)—the second mould plate 90 is then manually applied (as for FIG. 6). Instead of utilising the “one shot depositor”—see FIGS. 9 and 10—the mould cavities 91 are manually filled with chocolate—see FIG. 14. Excess chocolate is manually wiped away with a hand scraper.

The cooling and de-moulding steps are the same as the automated process.

By the present method, it is possible to produce the following combinations:

a) a chocolate product with a solid chocolate block having thin raised design with two or more colors; or

b) a chocolate product having a filled chocolate body with a thin raised design having one or more chocolate colors.

To date, neither option has been possible.

The use of the screens, in the modified screen printing applicator stations 50 enables the different colored chocolates to be applied to the patterns 10 in the first mould plates 20. The use of such screens has never before been contemplated and is a significant advance over the prior art.

Various changes and modifications may be made to the embodiments described and illustrated without departing from the present invention.

1. A method of forming a chocolate product having a thin (ie., three-dimensional) raised design thereon of two or more different colours than the rest (or body) of the chocolate product, said method comprising the steps of:
a) engraving a pattern in the first mould plate, the pattern being a mirror-image of the desired design on the product;
b) applying a screen to the first mould plate to limit exposure of the engraved pattern only to the portion, or portions, of a first colour;
c) introducing into the portion, or portions, sufficient liquid chocolate of the first colour to at least fill the portion or portions;
d) removing any excess material of the chocolate of the first colour from the first mould plate;
e) respectively repeating steps (b) to (d) respectively for the portion, or portions, of chocolates of second or more colours;
f) placing a second mould plate in non-slip contact, with the first mould plate, the second mould plate having a mould cavity of selected shape therein in register with the engraved pattern;
g) introducing liquid chocolate for the rest (or) body of the chocolate product into the mould cavity to cover the chocolate of the first and second (or more) colours;
h) cooling the different coloured chocolates in the mould plates to solidify them and bond (or meld) them together; and
i) removing the resultant chocolate product so formed from the mould plates.

2. A method as claimed in claim 1 wherein:
if the chocolate product is to be a filled chocolate product, the fill material and the liquid chocolate for the rest (or body) of the chocolate product are introduced simultaneously in step (g).

3. A method as claimed in claim 1 or claim 2 wherein:
where only chocolate of one colour is to be provided for the design on a filled chocolate product, step (3) is omitted.

4. A method as claimed in any one of claims 1 to 3 wherein:
a plurality of identical patterns are engraved in the first mould plate, the patterns having optional three dimensional features such as shape and height.

5. A method as claimed in claim 4 wherein:
a respective mould cavity for each pattern is provided in the second mould plate.

6. A method as claimed in any one of claims 1 to 5 wherein:
the first and second plates are formed of resilient plastics material, the first mould plate being formed from an engraving plastic laminate and the second mould plate being formed from a silicone rubber or polyurethane.

7. A method as claimed in any one of claims 1 to 6 wherein:
the mould cavities in the second mould plate have inclined or bevelled side walls to enable the chocolate products to be easily stripped therefrom; and in plan view are square, triangular, elliptical circular, heart-shaped, fan-shaped or any other regular or irregular shape.

8. Apparatus for forming a chocolate product having a thin (ie., three-dimensional) raised design thereon of two or more different colours than the rest (or body) of the chocolate product, the apparatus including:
a first mould plate, having at least one pattern, being a mirror-image of the design on the chocolate product, engraved in one face;
at least one screen operable to be applied to the one face of the first mould plate to limit exposure of the engraved pattern to a selected portion, or portions, of the pattern;
at least one nozzle means operable to introduce a chocolate of a first, or subsequent, colour to at least fill the exposed portion, or portions, of the pattern;
scraper means to remove any excess material of the chocolate of the first, or subsequent, colour from the first mould plate;
a second mould plate, having at least one mould cavity of selected shape to register with the, or each, engraved pattern in the first mould plate;
means to introduce liquid chocolate selected for the rest (or body) of the chocolate product into the mould cavity, or cavities, to cover the chocolate of the first and second (and other) colours; and
means to cool the chocolates in the mould plates to solidify them and to bond (or meld) them together.

9. Apparatus as claimed in claim 8 wherein:
a respective screen is provided for each colour of chocolate in the raised design.

10. Apparatus as claimed in claim 8 or claim 9 wherein:
the means to introduce the liquid chocolate into the mould cavity, or cavities, includes a first nozzle for the liquid chocolate and a second nozzle for a filling.

11. A chocolate product formed by the method of any one of claims 1 to 7.
